(19) United States
(12) Patent Application Publication
(10) Pub. No.: US 2019/0266672 A1
(43) Pub. Date: Aug. 29, 2019

(54) COLLABORATIVE REAL ESTATE INVESTING SYSTEM AND METHODOLOGY

(71) Applicant: NEWPORT EXCHANGE HOLDINGS, INC., Irvine, CA (US)

(72) Inventors: Diana Hill, Los Alamitos, CA (US); Steven Albin, Irvine, CA (US); Gaylene Galliford, Santa Ana, CA (US)

(73) Assignee: NEWPORT EXCHANGE HOLDINGS, INC., Irvine, CA (US)

(21) Appl. No.: 15/908,124

(22) Filed: Feb. 28, 2018

(51) Int. Cl. G06Q 40/06; G06Q 50/16; G06Q 40/04; G06Q 30/02; G06F 17/30

(52) U.S. Cl. CPC G06Q 40/06; G06Q 50/16; G06F 17/3053; G06Q 30/0283; G06Q 40/04

(57) ABSTRACT

Provided is a system and method for investing in a selected real property. Such investing addresses an optimization of collaboration between a seller of the selected real property and a potential buyer through disclosure of purchase criteria that pertains to the selected real property and forecasts of profit and loss which may result to the potential buyer from purchase.

### FIELD OF THE DISCLOSURE

Disclosed embodiments relate to wealth accumulation and management, and more specifically, to systems and methods for enabling investment in real property.

### BACKGROUND

Throughout time, real property, whether a vacant plot of land or structure, has provided many having the necessary means the ability to accumulate massive amounts of wealth. Simultaneously, such property has also served as a vehicle for the management of that wealth, relative to the employment of a variety of investment strategies targeted at minimizing long-term out-of-pocket expense.

In this regard, buyers and sellers alike share a commonality of purpose. Namely, each desires to maximize profit to be gained. To do so, these parties sometimes quickly switch roles and, as a result of doing so, often experience a windfall in favorable market conditions. This is especially true in geographical areas such as large metropolitan areas where population growth is spurred by employment opportunity and other factors viewed as attractive by prospective inhabitants. Among these factors are climate conditions, quality of educational resources, prospects for recreational activity, and proximity of outlets providing food and essentials.

Yet, a significant challenge exists for buyers and sellers in these and other areas. On the one hand, sellers must be able to find willing buyers for a host of property types, including rentals, family dwellings, and commercial structures. On the other hand, buyers must be able to assess whether what a seller is offering is a good deal or not. Considerations affecting this assessment include the above-discussed factors influencing population growth, the type and condition of the property, whether the property is subject to various encumbrances to title, e.g., a lien, etc. Even more, each of the buyer and seller needs to be able to deal with each other in a way that is transparent. This way, the validity of the sale of the real property involved is cast against the backdrop of mutual trust.

However, today's society is rife with marketplace participants who either try to actively conceal important details underlying a potential transaction, or worse, are ignorant to those details. The blame in each of these circumstances disproportionately falls on sellers who often try to “oversell” their properties. That is, information about such things as necessary repairs, truth regarding tax obligations, and encumbrances, for example, tend to fall through the cracks.

Thus, it would be desirable to provide a platform enabling buyers and sellers to engage each other in an online setting. More specifically, it would be desirable to provide such a setting in which sellers could offer their properties to buyers against the backdrop of disclosure of the value being presented. Still further, it would be desirable to enable such platform to provide a seller the tools necessary to expand the types of properties which are offerable to a buyer, and to provide a buyer tools enabling an accurate evaluation of a potential purchase.

### SUMMARY

It is to be understood that both the following summary and the detailed description are exemplary and explanatory and are intended to provide further explanation of the present embodiments as claimed. Neither the summary nor the description that follows is intended to define or limit the scope of the present embodiments to the particular features mentioned in the summary or in the description. Rather, the scope of the present embodiments is defined by the appended claims.

An aspect of the disclosed embodiments includes a system for investing in a selected real property, including one or more processors configured to execute computer program modules comprising a platform module configured to establish real property fields defining at least a location of the selected real property, a type of the selected real property, a ranked value and condition of the selected real property, and a type of a transaction corresponding to the type of the selected real property, the type of the transaction being defined by a seller of the selected real property, and in which the platform module further establishes one or more categories of selectable options for expanding a number of selections of real property corresponding to the type of the transaction, and a communications module configured to establish communications between the seller of the selected real property and a potential buyer thereof.

Another aspect of the disclosed embodiments includes a method of investing in a selected real property, including offering for sale the selected real property from a seller, and communicating the offer to a potential buyer, the offering including categorizing the selected real property by a type of a transaction corresponding to the type of the selected real property and a ranked value and condition of the selected real property, and disclosing to the potential buyer an estimation of a profit and loss to the potential buyer.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. Embodiments herein will be more particularly described in conjunction with the following drawings wherein:

FIG. 1 is a block diagram illustrating a system for investing in a real property, according to one or more embodiments;

FIG. 2 is a block diagram illustrating a transaction monitor according to the system of FIG. 1;

FIG. 3 is a block diagram illustrating a transaction selector according to the system of FIG. 1;

FIG. 3A shows a listing of selections implementable by a property expander of the transaction selector according to FIG. 3;

FIG. 3B shows a listing of functions implementable by a calculator of the transaction selector according to FIG. 3;

FIG. 4 shows a listing of selectable vendor selection options;

FIG. 5 is a flow diagram illustrating a method of investing in a selected real property according to one or more embodiments; and

FIG. 6 is a flow diagram illustrating a method of selection of a selectable vendor available to service a selected real property.

### DETAILED DESCRIPTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

The word “network” is used herein to mean one or more conventional or proprietary networks using an appropriate network data transmission protocol, or other specification and/or guidelines which may be applicable to the transfer of information. Examples of such networks include, PSTN, LAN, WAN, WiFi, WiMax, Internet, World Wide Web, Ethernet, other wireless networks, and the like.

The phrase “wireless device” is used herein to mean one or more conventional or proprietary devices using radio frequency transmission techniques or any other techniques enabling the transfer of information. Examples of such wireless devices include cellular telephones, desktop computers, laptop computers, handheld computers, electronic games, portable digital assistants, MP3 players, DVD players, or the like.

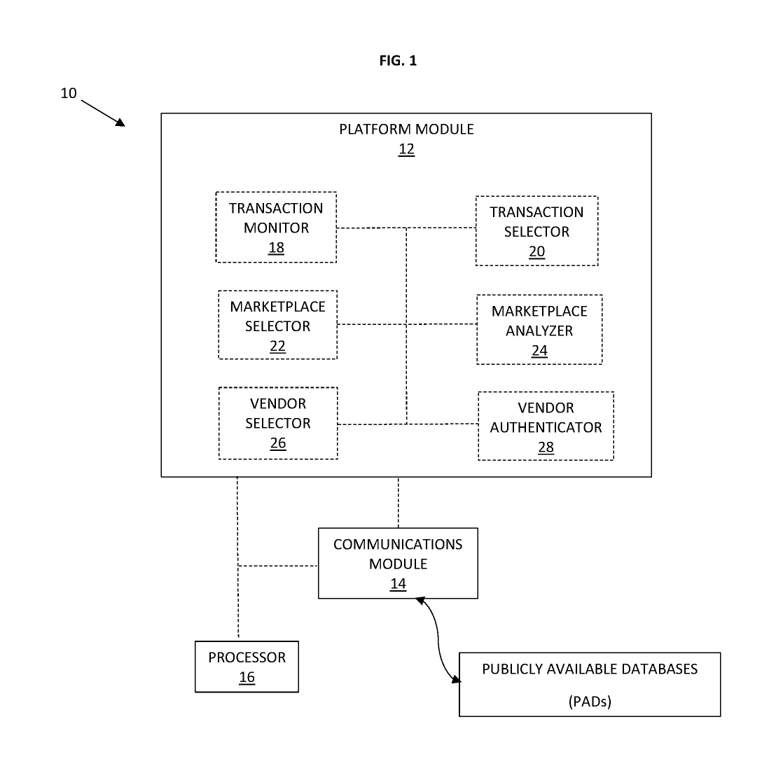

Referring now to FIG. 1, there is shown a system 10 for investing in a selected real property which includes a platform module 12 and a communications module 14 each of which is executable by processor 16. System 10 is optionally implemented by a server or personal wireless computing device, such as a laptop or smartphone. Platform module 12 and communications module 14 are operatively connected to processor 16, and comprise all appropriate hardware and/or software, including memory, enabling processor 16 to execute one or more set of instructions for carrying out the investment actions discussed herein. As discussed below, system 10 is operatively connected via communications module 14, either through wired or wireless connection, with publicly accessible databases (PADs) which pertain to the investment actions to be taken in accordance with embodiments disclosed herein. Further, system 10 may also be connected through the same wired or wireless connection to one or more networks for carrying the embodiments herein.

In this regard, platform module 12 includes a transaction monitor 18 and operatively connected transaction selector 20, a marketplace selector 22 and operatively connected marketplace analyzer 24, a vendor selector 26 and operatively connected vendor authenticator 28, and wherein each of the aforementioned is likewise operatively connected for communication of information therebetween as shown in FIG. 1.

From the standpoint of making any investment, whether in real property or other venture, an ability to monitor or track the progress of the same is crucial to the ability to know when to trigger or not trigger a particular investment action. Likewise, it is imperative to be able to assess the validity of the venture to which the investment action is targeted. Otherwise, the venture could pose nothing more than a fool's errand potentially eroding significant amounts of good-faith negotiation, trust, and even friendship between participants.

Today's real estate marketplace is a prime venue for investment in which the aforementioned monitoring and assessment are key to successful interaction between a seller and a potential buyer. In these regards, perhaps the most important facet of such interaction is a pathway for transparent communications so that each party may always be aware of what is required to obtain a desired outcome. Underpinning such transparency is a need to provide full disclosure for aspects of the investment opportunity.

Accordingly, the present embodiments aim to optimize collaborations between a seller of a selected real property and a potential buyer thereof, and in doing so, provide heightened transparency for an investment opportunity in that selected real property.

As such, the system 10 disclosed herein provides a portal accessible to both the seller and the buyer so as to enable each to use the tools provided. Access to the portal may be achieved through enrollment in a subscription-based plan administered by the operator of the system 10 and made available to enrollees for operation on, for example, a personal computing device.

Transaction monitor 18 and transaction selector 20 define tools which assist a seller of a selected real property with both the management of several listings as well as the opportunity to find and become educated about other properties which may represent potential acquisitions that may then be offerable to a potential buyer.

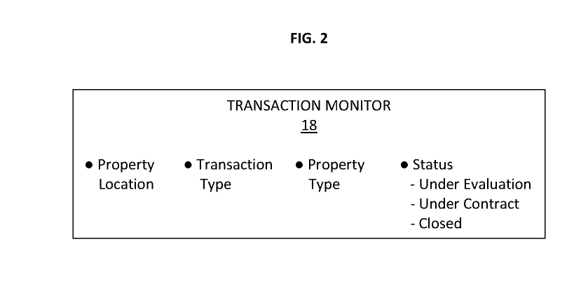

More specifically, and as shown in FIG. 2, transaction monitor 18 provides a seller the opportunity to monitor the status of all held properties as either, “Under Evaluation,” “Under Contract,” or “Closed.” Each property and its associated status, as is shown in FIG. 2, is monitored according to fields defining its location, transaction type, and property type. Notably, the transaction type is defined by the seller and contemplated to include either wholesale, rehabilitation (rehab), rental, residential, or commercial, though other transaction types may also be included. The property type is contemplated to include, for example, a multitude of real property types, such as condominium, single family residence, specified unit rental, commercial, retail, office, and industrial. Accordingly, the status of a particular transaction pertaining to a particular property may be made available to the seller upon sorting of one or more of the aforementioned fields. Alternatively, a seller may use the transaction monitor 18 to sort through properties having a given status by selection of the same.

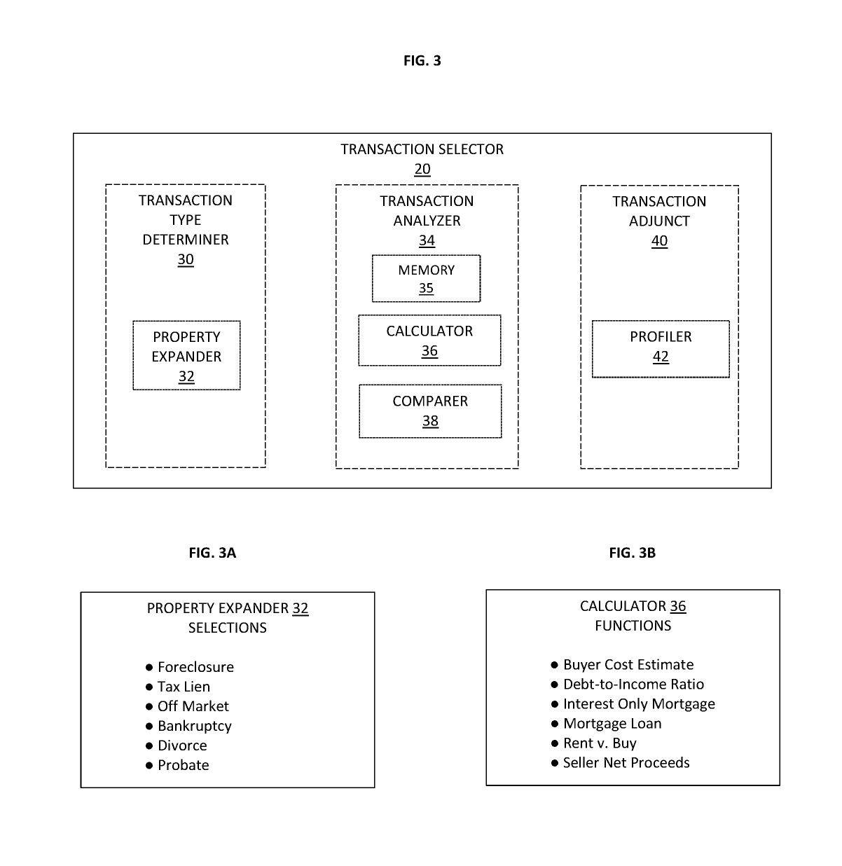

In referring to FIG. 3, transaction selector 20 provides a seller an ability to perform a number of tasks with respect to a particular real property or properties to be monitored through use of transaction monitor 18. For instance, such tasks include, by way of non-limiting example, (1) expanding a number of real properties which a seller may offer for sale to a potential buyer, (2) analyzing proceeds which may result from that sale, and (3) profiling a particular property to learn historical information thereof.

More specifically, transaction selector 20 enables a seller to select from among wholesale, rehab, rental, residential, and commercial types of transactions through use of transaction type determiner 30. Once implemented to select a particular type of transaction, transaction type determiner 30 is configured to execute its property expander 32. Property expander 32 implements and displays categories of options for allowing a seller to explore/investigate available real properties corresponding to the type of transaction, as shown in FIG. 3A. In this way, a seller may expand her portfolio of real properties which may be offerable for sale and monitored using transaction monitor 18. As an example, property expander 32 is configured to, in the cases of wholesale, rental, residential, and commercial types of transactions, provide a seller the opportunity to identify real properties subject to foreclosure, tax lien and/or other encumbrance that would provide an opportunity for acquisition. Additionally, property expander is 32 is also configured to compile targeted lists of owners of “off market” properties, i.e., properties not currently listed for sale.

In the case in which the type of transaction is rehab, property expander 32 is configured to provide a seller the opportunity to identify real properties subject to foreclosure, bankruptcy, divorce and probate, in addition to creating the above-discussed lists of off-market properties.

In order to effect its identification of the real properties noted above, property expander 32 conducts searching of all publicly available databases (PADs), as shown in FIG. 1, and other information sources which are particular to a local of interest and contain pertinent property characteristics including, but not limited to, judicial records, commercially available listing service records and individual postings.

Though the above transaction type determiner 30 has been described as being of use to a seller, it is likewise available to a potential buyer of a selected real property insofar as such potential buyer has access to view those real properties made offerable for sale by a seller.

Thus, in concert with the options provided by transaction selector 20, and specifically transaction type determiner 30, transaction selector 20 further includes a transaction analyzer 34. Transaction analyzer 34 itself includes a calculator 36, like that which is available from DINKYTOWN.NET, of Minneapolis, Minn., and comparer 38 for assisting sellers and buyers to assess the worthiness of entering into a particular agreement for a selected real property.

In this regard, and as may been in FIG. 3B, calculator 36 is configured to calculate purchase criteria such as, and in relation to, a plurality of sell/purchase parameters including, for example, a buyer cost estimate for purchase of a selected real property, a debt-to-income ratio to assist a buyer with estimation of purchasing power, interest only assessment providing an amortization schedule of interest on an interest only mortgage, an amortization schedule for a current mortgage loan, an assessment as to whether to rent or buy, and an amount of seller net proceeds regarding a particular transaction for a selected real property. As an example, calculator 36, when assessing whether to rent or buy a selected real property, is configured to determine the percentage difference in cost of purchase versus rental, taking into account such factors as mortgage amount, applicable taxes, homeowners' association (HOA) fees, maintenance fees and insurance fees, etc.

Against the backdrop of assessments provided through use of calculator 36, comparer 38 is configured to provide a seller or potential buyer a selection of comparable real properties based on publicly available information such as the sale amount listed by an owner, the rental amount listed by an owner, and other criteria such as government fees including, for example, annual tax amounts.

Armed with the information provided by calculator 36 and comparer 38, either a seller or a potential buyer is also enabled to use transaction selector 30 to perform selected tasks for a selected real property which the seller or the potential buyer has decided to sell/purchase. In particular, transaction adjunct 40 includes a profiler 42 containing a legal document portal enabling access to form legal documents pertinent to real property transactions, a search assistant configured to search all publicly available records to determine and verify ownership for a selected real property, as well as a portal for receiving entries from buyers capable of cash purchasing.

Referring again to FIG. 1, and when considering the location of a selected real property which be the basis of any of the above transaction types, a seller or potential buyer must also be informed as to the historical and current trending of real property value and conditions in a particular local, whether a country, a state, a county, or a municipality. In this regard, platform module 12 includes a marketplace selector 22 configured to provide pertinent value and condition information for a selected real property that is being considered. Such information is collected from publicly available sources, as from, for example, PADs, such as realtors' associations and state and local government forecasts. Based on this information, and specifically factors such as median list price and available inventory, marketplace selector 22 is configured to provide a buy or sell recommendation for the market relevant to the local of the selected real property being considered for sale or purchase.

Marketplace analyzer 24 provides a portal containing real properties made offerable for sale by one or more sellers of selected real properties. Through this portal, a potential buyer may view a depiction of the real property along with an assessment of purchase criteria including an estimation of profit and loss to the potential buyer for the selected real property being considered. For example, when considering a rental transaction, a potential buyer may consider the estimation provided by a seller, in which the estimation may be based upon past, current and/or future components pertinent to the selected real property. That is, the estimation may be based upon, for example, future rent collection projections, lost rent, vacancy, loan costs, rehab and maintenance costs, insurance costs, tax costs and collected rent. In sum, an exemplary rental scenario encapsulating purchase criteria providing an estimation of annual profit and loss that is viewable to a potential buyer through the marketplace analyzer 24 may be displayed as shown in Table 1 below.

TABLE 1
DETAILS x

| Name | RDH, LLC |
|---|---|
| Location | orange, CA |
| List Price | $900,000 |

PROPERTY DETAILS

| | |
|---|---|
| Type | 2-4 Unit Rental |
| Units | Triplex |
| Occupancy | Occupancy |
| Bedrooms | |
| Bathrooms | |

OPERATING DETAILS PRO FORMA

| | |
|---|---|
| Operating Revenue | $4,020.65 |
| Total Operating Expenses | $914.93 |
| Net Operating Income | $3,105.72 |

KEY METRICS

| | |
|---|---|
| Est. CADS | $1,699.30 |
| (Cash After Debt Service) | |
| Estimated Return on Cash | 20.39% |
| CAP Rate | |
| *Calculated using Annual NOI | 9.32% |
| DSCR (Debt Service Cover Ratio) | 2.21 |
| *Calculated using Annual NOI | |

Therein, Table 1 includes an estimated annual profit (i.e., CADS) of $1,699.30 that is viewable to a potential buyer when considering whether to purchase the selected real property addressed therein.

Thus, it will be understood that other types of real property transactions, including wholesale, rehab, residential and commercial, and offerings for sale in association therewith, will detail various criteria in their applicable estimate of profit and loss.

Marketplace analyzer 24, through communications module 14, is further configured to receive and transmit communications between a seller and a potential buyer with respect to the purchase criteria displayed therein. As is often the case, a main subject of such communications will likely center on the sale amount and negotiations in regard thereto.

Accordingly, marketplace analyzer 24 is thus configured to execute an algorithm so as to rank real properties shown therein according to a potential investment opportunity score, e.g., 0-100. This score is contemplated to reflect components pertinent to a selected real property which are included in the score's calculation at the discretion of the seller, as well as a seller's adjustment of the sale amount. That is, the investment opportunity score for a selected real property may be increased, in accordance with a discretionary increment determined by the operator of the platform module 12, for every decrease in the sale amount, as determined by the seller. This way, a potential buyer may view real properties according to their investment opportunity scores, at least one of which may have been achieved, in part, through negotiation with a seller of the selected real property in question that resulted in an adjustment of the listed sale amount.

More specifically, when a selected real property is offered for sale through marketplace analyzer 24, it is contemplated that the corresponding investment opportunity score for the selected real property, along with the components defining the seller's calculation of that score, will each be viewable by a potential buyer when viewing the selected real property. Such components may be variously weighted by the seller, or operator of the platform module 12, and fed into an algorithm which applies those weightings, and ultimately determines the respective investment opportunity scores to be posted with the selected real properties that are viewable by a potential buyer.

The aforementioned components defining the seller's calculation may include, for example, one or more of the following items: (1) cash-on-cash return; (2) down payment threshold preference; (3) local area ranking; (4) age of the selected real property; (5) present condition of the selected real property; (6) amenities included with the selected real property; (7) prior percentage appreciation of the selected real property; and (8) current pricing versus market average amount. That is, other components or variations of the above may also be considered in the seller's calculation depending upon various conditions of the seller. Also, it is to be understood that the above enumerated components will be determined by the seller in accordance with, for example, the seller's preferences for a particular transaction, general knowledge of a selected real property, general knowledge of the local in which the selected real property is situated, and information obtainable through use of, for instance, marketplace selector 22 and/or marketplace analyzer 24.

For example, item (3) may defined in accordance with an online or in-person visual “scouting” of the local area for the selected real property. This scouting may consider one or more of the following: types of land and building use (e.g., residential single-family homes); availability of parking; transportation options and availability; a number of and accessibility to government services and facilities (e.g., public parks); present and projected crime rate; general upkeep of land and buildings; accessibility to grocery and pharmacy outlets; noise level; overall attractiveness (e.g. absence of overhead powerlines); and/or undesirable current or proposed neighborhood restrictions affecting the use of land or buildings.

Such scouting may also assess one or more of the following: presence and ranking of educational institutions; recreational options (e.g., theater, bike trails, and sporting events); availability of access to water, including rivers, lakes and oceans; ease of walking to facilities; types and quality of employment options; length of employer presence; home ownership appreciation rate; land and building vacancy rate; style of homes and buildings relative to the selected real property; and/or uniformity of zoning.

As yet a further example, item (5) may be defined, for example, in terms of whether the selected real property is in need of rehab, such that an “Estimated Fix-Up Budget” (EFUB) needs to be prepared. In this regard, both the EFUB and an actual fix-up budget may be prepared relative to an online and/or in-person inspection of the selected real property. Thus, marketplace analyzer 24 is configured to calculate the EFUB based on the square footage (sf) of the selected real property according to a categorization resulting from the aforementioned inspection(s), as well as level of desired rehab selected by the seller. That categorization provides various levels of rehab along with an associated dollar value. Such levels and associations may be as follows: Basic Low ($10/sf), Basic High ($15/sf), Standard Low ($18/sf), Standard High ($20/sf), Premium Low ($23/sf), and Premium High ($30/sf). For example, the EFUB in Example 1 below is calculated by multiplying the square footage of 624 by the dollar value of $10/sf (in accordance with the Basic Low category) to arrive at an EFUB of $6,240. The various categories shown therein (Large Structural, Small Structural, Cosmetic Interior, Cosmetic Exterior and Other) result from the inspection(s) discussed above. As such, the determined percentages, e.g., Cosmetic Interior—Floors at 25.00%, are then applied against the EFUB to arrive at an EFUB estimation for that particular item, whereby the aforementioned yields a rehab amount of $1,560.00.

Below are example assessments for each of the above components and their associated point value weightings that may be used by marketplace analyzer 24 when calculating a particular investment opportunity score for a selected real property.
(1) Cash-on-cash return:
   If 0-25%, then 5 points,
      26-49%, then 10 points,
      50-74%, then 15 points, and
      75-100%, then 20 points;
(2) Downpayment Threshold Preference:
   If $ 0-50,000, then 5 points,
      51,000-75,000, then 10 points,
      76,000-100,000, then 15 points, and
      101,000-200,000, then 20 points;
(3) Local Area Ranking:
   If Good, then 1 point,
      Very Good, then 2 points,
      Excellent, then 3 points, and
      Superior, then 5 points;
(4) Age of Property:
   If less than or equal to 5 years, then 5 points,
      more than 5 years, but less than or equal to 10 years, then 3 points,
      more than 10 years, but less than or equal to 20 years, then 2 points, and
      more than 20 years, then 1 point;
(5) Present Condition of Property:
   If Good, then 1 point,
      Very Good, then 2 points,
      Excellent, then 3 points, and
      Superior, then 5 points;
(6) Amenities:
   If Good, then 1 point,
      Very Good, then 2 points,
      Excellent, then 3 points, and
      Superior, then 5 points;
(7) Percentage Appreciation (Over Selected Period):
   If less than or equal to 5%, then 5 points,
      more than 5%, but less than or equal to 10%, then 10 points,
      more than 10%, but less than or equal to 15%, then 15 points, and
      more than 15%, then 20 points; and
(8) Current Pricing Amount Below Market Average:
   If less than or equal to 5%, then 5 points,
      more than 5%, but less than or equal to 10%, then 10 points,
      more than 10%, but less than or equal to 15%, then 15 points, and
      more than 15%, then 20 points.

In view of the above, an example investment opportunity score for a new apartment, in a rental transaction and in which cash-on-cash return is 26%, downpayment preference is $51,000, the local area, condition of the property and amenities are superior, appreciation (over a 5 year period) and pricing below market are each 12%, would be 70. Assuming that the current sale amount is $520,000, lowering thereof by the seller to $480,000 would, at the option of the operator of the platform module 12, raise the investment opportunity by 10 points to achieve a score of 80.

Thus, when a potential buyer is using marketplace analyzer 24 to review those properties offered by one or several sellers, such properties may be ranked according to a highest investment opportunity score to a lowest thereof. Further, any grouping of properties may be sorted either according to their calculated investment opportunity score and/or any one component thereof as described above. This way, such buyer may become informed on those components which are important to their purchase decision. Likewise, through interaction with a potential buyer, a seller may learn of the particular components that are of particular interest to a particular potential buyer so that adjustment of any one component may be made in order to facilitate and/or expedite sale of a selected real property.

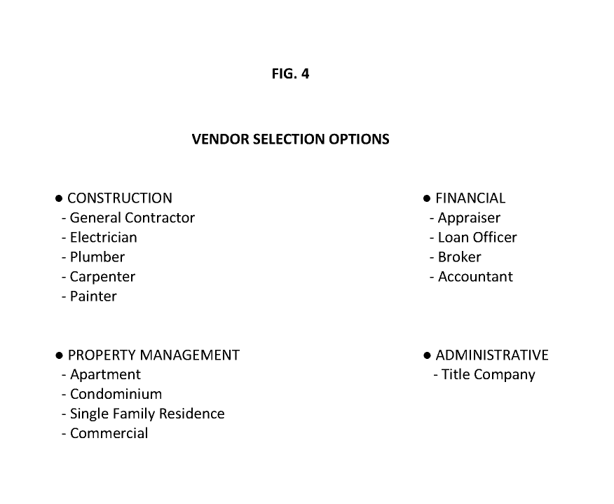

Referring again to FIG. 1, platform module 26 is further configured to include a vendor selector 26. Vendor selector 26 provides an exemplary selection of appropriate vendors, such as those shown in FIG. 4. Therein, vendor selector 26 is contemplated to provide an array of variously selectable vendors available to service a selected real property being considered for purchase, or which has been purchased. As shown, the array includes an exemplary assortment of types of vendors spanning subject areas including construction, financial, property management, and administrative. More specifically, construction vendors may include a general contractor, an electrician, a plumber, a carpenter, and a painter, while financial vendors may include an appraiser, a loan officer, a broker, and an accountant. Property management vendors may be selected from those available to service apartments, condominiums, single family residences and commercial properties, while an administrative vendor may include a title company.

Notably, availability of a particular vendor is determined based on whether the vendor, on a case-by-case basis with respect to the type of the vendor and constraints imposed by law, is able to service the selected real property in accordance with an estimation of profit and loss made available by the seller through marketplace analyzer 24. To assess such availability, transaction analyzer 34, as shown in FIG. 3, is configured to receive and store in a memory 35 thereof, bids offered by vendors interested in servicing a selected real property according to a projected cost of rehab, cost of maintenance, or initial service estimate. Based on such storage, a seller may then assess the submitted bids and select the vendor whose bid most closely aligns with the seller's initial cost estimates. Alignment of the bid with the seller's initial cost estimates, it will be understood, may be determined based on a vendor's familiarity with types of property offered, for example, in a particular local and the servicing needs that may be specific to that local. For example, in a case in which the transaction type is rental, a contractor may have specific knowledge that a projected profit is unobtainable based on the condition of the property and/or local government requirements for materials necessary to carry out rehab and/or maintenance.

Once selected, a seller may then authenticate the vendor through use of vendor authenticator 28, which provides access to public databases, i.e., PADs, containing information regarding criminal history, civil adjudication and overall integrity so as to effect, essentially, a background check. As such, the seller may be assured of a level of reliability that may be placed in the vendor and the bid submitted.

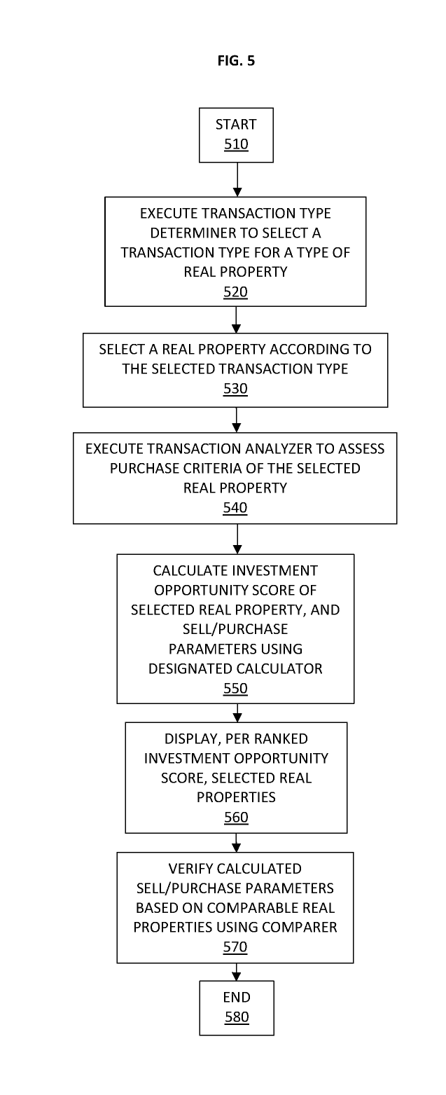

Referring now to FIG. 5, there is shown a method of investing in a selected real property according to one or more disclosed embodiments. Each of the types of transactions including wholesale, rehab, rental, residential, and commercial may be the subject matter of the method to be discussed hereinbelow. In this regard, one or more types of real property suitable to the particular type of transaction may serve as the selected real property, such that it is to be understood that the term, “selected real property,” means a building and/or parcel of land which is the subject matter of consideration by a seller or potential buyer, and/or negotiation between a seller and a potential buyer/buyer.

The method initiates at step 510 and proceeds to step 520 whereat either a seller or potential buyer executes transaction type determiner 30 to select a transaction type among wholesale, rehab, rental, residential, or commercial for a suitable type of real property including, for example, an office, a single family residence, or a condominium, etc. Once the type of transaction is selected, either the seller or potential buyer may then actually select, at step 530, a real property using, for example, marketplace selector 22 and marketplace analyzer 24. Once the real property is selected, either the seller or potential buyer may then execute, at step 540, transaction analyzer 34, as shown in FIG. 3, to assess purchase criteria of the selected real property by, for example, comparing whether to rent or purchase the selected real property. As has been discussed above, the purchase criteria includes an estimation of projected profit and loss as determined by the seller of the selected real property, and which is viewable by the potential buyer when viewing the selected real property through use of the marketplace analyzer 24. At step 550, transaction analyzer 34 is executed to calculate an investment opportunity score for the selected real property. Assessment of the offering for sale as provided by the seller may be conducted through use of calculator 36 and comparer 38 as defined by transaction analyzer 34. As will be appreciated from the above discussions regarding calculator 36 and comparer 38, and from a general knowledge of investing as well, the aforementioned estimation is optimally implemented in a stepwise process such that calculator 36 ought to be first used to calculate, as further indicated at step 550, the sell/purchase parameters of the offering for sale using the appropriate calculator according to FIG. 3A. In other words, whether from the standpoint of the seller or the potential buyer, the relevant party is enabled to investigate parameters of the offering relative to, in the case of the seller, potential net proceeds from a sale based on a potential buyer's offered purchase amount and, in the case of the potential buyer, whether, for instance, the selected real property underlying the particular offering is a more appropriate for rental or purchase. Thereafter, at step 560, the selected real property and its investment opportunity score are displayed, in accordance with a highest to lowest ranking, by marketplace analyzer 24 along with components defining that score. At step 570, a seller or potential buyer may then execute comparer 38 to verify the calculated sell/purchase parameters relative to comparable real properties for the particular local in which the selected real property is situated, and profiler 42 to verify ownership. Once verification is completed, the seller or potential buyer may then decide to accept the other's terms and proceed to final negotiation for the selected real property, at which point the investment analysis ends at step 580 for the selected real property.

As discussed hereinabove, the purchase criteria defining an offering for sale made by a seller may include, as a component thereof, the costs of rehab, maintenance or initial service by a vendor. Such costs contribute to the definition of the seller's estimated profit and loss, and thus impact the consideration to be given by a potential buyer for a selected real property in which the offering therefor is partly based on the vendor's costs.

Accordingly, it is important to be able to select a vendor able to comport with the above estimation so as to maintain its integrity and value to the overall offering for sale.

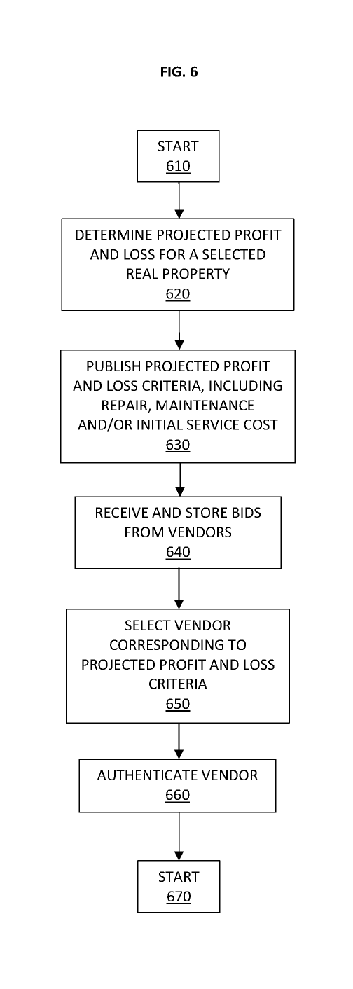

With this in mind, FIG. 6 illustrates a method for selection of a vendor able to service a selected real property, and begins at step 610. At step 620, a seller of a selected real property determines an estimated profit and loss therefor in the context of those cost amounts which the seller is willing to pay for such things as rehab, maintenance and initial service costs. At step 630, the seller publishes the estimation as part of the offering for sale. At step 640, transaction analyzer 34 receives and stores bids from vendors able to service the selected real property according to the estimation.

At step 650, a seller of the selected real property may then review the submitted bids and select that vendor whose bid most closely aligns with the projected estimation. Once selected, the seller may then execute vendor authenticator 28, at step 660, to verify aspects for the vendor which may impact a final selection decision before the process ends at step 670.

Thus, in view of the above, there is provided a system and method for investing in a selected real property that enables an optimization of collaboration and relations between a seller of the selected real property and a potential buyer thereof. Such optimization is achieved at least through a transparency in disclosure by a seller of details pertaining to an offering for sale which are necessary to fully inform a potential buyer's decision to consider for purchase the selected real property.

In practice, provided below are a set of examples of transaction offerings implemented according to the present system and method to effect the aforementioned disclosure. Example 1 addresses a wholesale offering for sale of a single family residence, and sets forth those materials which would be obtainable by a potential buyer through marketplace analyzer 24. As shown, the materials address the wholesaler's profit, costs to the potential buyer upon purchase, and the potential buyer's profit ($2,720 based on (Sale Price−Total Expenses)).

### EXAMPLE 1

Deal Criteria

| Bakersfield | | | |
|---|---|---|---|
| The P & L is based on the following criteria: | | | |
| Closing Cost In | 0.50% | Insurance Rate/Year | 0.50% |
| Loan Interest Rate | 5.00% | Tax Rate/Year | 1.00% |
| Loan Term (Years) | 30 | Closing Cost Out | 7.00% |
| Holding Period (Mo) | 6 | Sales Agent Fee | 0.00% |

Projected Profit & Loss

| | | | |
|---|---|---|---|
| Income | | Expenses | |
| Sale Price | $82,000.00 | * Loan Payment(s) | $0.00 |
| Expense | | * Insurance & Taxes | $480.00 |
| Down Payment | $0.00 | Estimated Fix Up Budget | $6,240.00 |
| Closing Cost In | $320.00 | Actual Fix Up Budget | $0.00 |
| | | Wholesalers Profit | $2,500.00 |
| | | Closing Cost Out | $5,740.00 |
| | | Sales Agent Fee | $0.00 |
| | | Total Holding Expense | $15,280.00 |
| | | Loan Payoff | $64,000.00 |
| | | Estimated Profit | $2,720.00 |

*Amount calculated using the holding period as indicated by the deal criteria.

Estimated Fix Up Budget

Budget Criteria

| | |
|---|---|
| Square Feet | 624 |
| Budget Category | Basic Low ($10/sf) |
| Budget | $6,240.00 |

| Description | Unit % | Budget | Actual | Variance |
|---|---|---|---|---|
| Large Structural | 0.00% | $0.00 | $0.00 | $0.00 |
| Roof | 0.00% | $0.00 | $0.00 | $0.00 |
| Foundation | 0.00% | $0.00 | $0.00 | $0.00 |
| Plumbing | 0.00% | $0.00 | $0.00 | $0.00 |
| Electrical | 0.00% | $0.00 | $0.00 | $0.00 |
| Small Structural | 25.00% | $1,560.00 | $0.00 | $−1,560.00 |
| Windows | 0.00% | $0.00 | $0.00 | $0.00 |
| Walls | 20.00% | $1,248.00 | $0.00 | $−1,248.00 |
| Moving of Walls | 0.00% | $0.00 | $0.00 | $0.00 |
| Lighting | 5.00% | $312.00 | $0.00 | $−312.00 |
| Bathrooms(s) | 0.00% | $0.00 | $0.00 | $0.00 |
| Kitchen | 0.00% | $0.00 | $0.00 | $0.00 |
| Cosmetic Interior | 45.00% | $2,808.00 | $0.00 | $−2,808.00 |
| Doors | 0.00% | $0.00 | $0.00 | $0.00 |
| Trim | 0.00% | $0.00 | $0.00 | $0.00 |
| Paint | 20.00% | $1,248.00 | $0.00 | $−1,248.00 |
| Floors | 25.00% | $1,560.00 | $0.00 | $−1,560.00 |
| Cosmetic Exterior | 30.00% | $1,872.00 | $0.00 | $−1,872.00 |
| Front door | 5.00% | $312.00 | $0.00 | $−312.00 |
| Garage door | 5.00% | $312.00 | $0.00 | $−312.00 |
| Walkway | 5.00% | $312.00 | $0.00 | $−312.00 |
| Driveway | 5.00% | $312.00 | $0.00 | $−312.00 |
| Backyard | 5.00% | $312.00 | $0.00 | $−312.00 |
| Curb appeal | 5.00% | $312.00 | $0.00 | $−312.00 |
| Other | 0.00% | $0.00 | $0.00 | $0.00 |
| Other | 0.00% | $0.00 | $0.00 | $0.00 |
| HVAC | 0.00% | $0.00 | $0.00 | $0.00 |
| Total | 100.00% | | $0.00 | $−6,240.00 |

Example 2 address a rehab offering for sale of a single family residence in which a potential buyer's profit is clearly set forth, based on a calculation similar to that provided above in the context of the wholesale offering for sale of Example 1.

### EXAMPLE 2

Deal Criteria

| Rose | | | |
|---|---|---|---|
| The P & L is based on the following criteria: | | | |
| Closing Cost In | 0.50% | Tax Rate/Year | 1.25% |
| Hard Money Loan Cost | 0.00% | Closing Cost Out | 7.00% |
| Loan Interest Rate | 4.50% | Sales Agent Fee | 0.00% |
| Loan Term (Years) | 30 | Holding Period (Mo) | 3 |
| Insurance Rate/Year | 0.50% | | |

Projected Profit & Loss

| | | | |
|---|---|---|---|
| Income | | Expenses | |
| Sale Price | $470,000.00 | * Loan Payment(s) | $1,773.40 |
| Expense | | * Insurance & Taxes | $1,531.25 |
| Down Payment | $0.00 | Estimated Fix Up Budget | $−2,000.00 |
| Closing Cost In | $1,750.00 | Actual Fix Up Budget | $24,500.00 |
| | | Closing Cost Out | $32,900.00 |
| | | Sales Agent Fee | $0.00 |
| | | Total Holding Expense | $62,454.65 |
| | | Loan Payoff | $350,000.00 |
| | | Estimated Profit | $57,545.35 |

* Amount calculated using the holding period as indicated by the deal criteria.

Estimated Fix Up Budget

Budget Criteria

| | |
|---|---|
| Square Feet | 1,250 |
| Budget Category | Standard Low ($18/sf) |
| Budget | $22,500.00 |

| Description | Unit % | Budget | Actual | Variance |
|---|---|---|---|---|
| Large Structural | 0.00% | $0.00 | $22,500.00 | $22,500.00 |
| Roof | 0.00% | $0.00 | $6,500.00 | $6,500.00 |
| Foundation | 0.00% | $0.00 | $6,000.00 | $6,000.00 |
| Plumbing | 0.00% | $0.00 | $10,000.00 | $10,000.00 |
| Electrical | 0.00% | $0.00 | $0.00 | $0.00 |
| Small Structural | 23.00% | $5,175.00 | $2,000.00 | $−3,175.00 |
| Windows | 4.00% | $900.00 | $0.00 | $−900.00 |
| Walls | 15.00% | $3,375.00 | $2,000.00 | $−1,375.00 |
| Moving of Walls | 0.00% | $0.00 | $0.00 | $0.00 |
| Lighting | 4.00% | $900.00 | $0.00 | $−900.00 |
| Bathrooms(s) | 0.00% | $0.00 | $0.00 | $0.00 |
| Kitchen | 0.00% | $0.00 | $0.00 | $0.00 |
| Cosmetic Interior | 53.00% | $11,925.00 | $0.00 | $−11,925.00 |
| Doors | 4.00% | $900.00 | $0.00 | $−900.00 |
| Trim | 4.00% | $900.00 | $0.00 | $−900.00 |
| Paint | 25.00% | $5,625.00 | $0.00 | $−5,625.00 |
| Floors | 20.00% | $4,500.00 | $0.00 | $−4,500.00 |
| Cosmetic Exterior | 24.00% | $5,400.00 | $0.00 | $−5,400.00 |
| Front door | 4.00% | $900.00 | $0.00 | $−900.00 |
| Garage door | 4.00% | $900.00 | $0.00 | $−900.00 |
| Walkway | 4.00% | $900.00 | $0.00 | $−900.00 |
| Driveway | 4.00% | $900.00 | $0.00 | $−900.00 |
| Backyard | 4.00% | $900.00 | $0.00 | $−900.00 |
| Curb appeal | 4.00% | $900.00 | $0.00 | $−900.00 |
| Other | 0.00% | $0.00 | $0.00 | $0.00 |
| Other | 0.00% | $0.00 | $0.00 | $0.00 |
| HVAC | 0.00% | $0.00 | $0.00 | $0.00 |
| Total | 100.00% | | $24,500.00 | $2,000.00 |

What is claimed is:

1. A system for investing in a selected real property, comprising:
one or more processors configured to execute computer program modules comprising
a platform module configured to establish real property fields defining at least a location of the selected real property, a type of the selected real property, a ranked value and condition for the selected real property, and a type of a transaction corresponding to the type of the selected real property, the type of the transaction being defined by a seller of the selected real property, and in which
the platform module further establishes one or more categories of selectable options for expanding a number of selections of real property corresponding to the type of the transaction; and
a communications module configured to establish communications between the seller of the selected real property and a potential buyer thereof.

2. The system of claim 1, wherein:
the type of the transaction corresponding to the type of the selected real property comprises wholesale, or rehab, or rental, or residential, or commercial.

3. The system of claim 2, wherein:
the platform module is further configured to display the type of the transaction corresponding to the type of the selected real property together with purchase criteria for the corresponding, selected real property.

4. The system of claim 3, wherein:
the purchase criteria comprises an estimation of profit and loss to the potential buyer.

5. The system of claim 4, wherein:
the estimation of profit and loss to the potential buyer is viewable by the potential buyer of the selected real property.

6. The system of claim 5, wherein:
the communications module is configured to establish a pool of potential buyers for the selected real property.

7. The system of claim 6, wherein:
the platform module is further configured to rank the selected real property in accordance with an investment opportunity score corresponding to at least a sale amount for the selected real property.

8. The system of claim 7, wherein:
the platform module further establishes a network of selectable vendors available to service the selected real property, in accordance with components defining the profit and loss to the potential buyer.

9. The system of claim 8, wherein:
the components defining the profit and loss to the potential buyer comprise a cost of rehab, or a cost of maintenance for the selected real property, or an initial service cost of a vendor, or a combination thereof.

10. The system of claim 9, wherein:
the platform module is configured to select a vendor in response to receipt of a bid for rehab or maintenance, submitted by the selected vendor and which corresponds to the associated cost for the rehab, or the maintenance, or the initial service, or a combination thereof.

11. A method of investing in a selected real property, comprising:
offering for sale the selected real property from a seller; and
communicating the offer to a potential buyer,
the offering comprising categorizing the selected real property by a type of a transaction corresponding to the type of the selected real property and a ranked value and condition of the selected real property, and disclosing to the potential buyer an estimation of a profit and loss to the potential buyer.

12. The method of claim 11, wherein:
the type of the transaction comprises wholesale, or rehab, or rental, or residential, or commercial.

13. The method of claim 12, wherein:
the estimation of profit and loss to the potential buyer is based on past costs to the seller.

14. The method of claim 13, wherein:
the estimation of the profit and loss to the potential buyer is further based on a projection of costs and/or income corresponding to type of the transaction for the selected real property.

15. The method of claim 14, further comprising:
providing a network of selectable vendors available to service the selected real property, in accordance with the estimation of profit and loss.

16. The method of claim 15, wherein:
a vendor of the network of selectable vendors available to service the selected real property is selectable in response to submission of a bid corresponding to the estimation of profit and loss.

17. The method of claim 16, wherein:
the projection is based on an anticipated cost of rehab, or an anticipated cost of maintenance, or an anticipated initial service cost of a vendor for the selected real property, or a combination thereof.

18. The method of claim 17, further comprising:
ranking the offering for sale among a plurality of offerings for sale based upon an investment opportunity score corresponding to the sale amount.

19. The method of claim 18, wherein:
the investment opportunity score is increased in response to a lowering of the sale amount.

20. The method of 19, wherein:
the investment opportunity score corresponds to, with respect to the selected real property, one or more components including (a) a cash-on-cash return; (b) a down payment threshold preference; (c) a local area ranking; (d) an age of selected real property; (e) a present condition of the selected real property; (f) amenities included with selected real property; (g) prior percentage appreciation of the selected real property; and (h) current pricing of the selected real property versus a market average amount.

21. The method of claim 20, wherein:
the local area ranking assesses, at least, an availability of transportation options and their accessibility and the presence and ranking of educational institutions.

22. The method of claim 21, wherein:
a present condition of the selected real property is based on a level of rehab for the selected real property.

23. The method of claim 22, wherein:
displaying the selected real property, corresponding investment opportunity score, and components of the corresponding investment opportunity score to the potential buyer.
